(19) United States
(12) Patent Application Publication
(10) Pub. No.: US 2013/0328676 A1
(43) Pub. Date: Dec. 12, 2013

(54) OUTPUT DEVICE FOR ISSUING A WARNING NOTICE

(71) Applicant: GM GLOBAL TECHNOLOGY OPERATIONS LLC, Detroit, MI (US)

(72) Inventors: Stefan BAUER, Wiesbaden (DE); Oliver SCHEPP, Idstein (DE); Oliver WAGNER, Gross-Gerau (DE)

(73) Assignee: GM GLOBAL TECHNOLOGY OPERATIONS LLC, Detroit, MI (US)

(21) Appl. No.: 13/836,252

(22) Filed: Mar. 15, 2013

(30) Foreign Application Priority Data
Jun. 9, 2012 (DE) 10 2012 011 506.7

(51) Int. Cl. B60R 22/48

(52) U.S. Cl. CPC B60R 22/48
USPC 340/457.1

(57) ABSTRACT

An output device with an output unit for issuing a warning notice is provided. The output device comprises a seat occupancy sensor which is connected with a control device for activating the output unit and which is designed, in case a safety belt on a rear seat comprising a foldable back rest has not been applied, to activate the output unit via the control device. The output device comprises a switch or button which is designed to block activation of the output unit by the control device, if the back rest is not in a sitting position.

### CROSS-REFERENCE TO RELATED APPLICATION

This application claims priority to German Patent Application No. 10 2012 011 506.7, filed Jun. 9, 2012, which is incorporated herein by reference in its entirety.

### TECHNICAL FIELD

An output device with an output unit for issuing a warning notice, which device can be activated by means of a seat-occupancy sensor connected with a control device for activating the output unit, if a safety belt of a rear seat comprising a foldable back rest is not used.

### BACKGROUND

The U.S. Pat. No. 7,192,089 describes a rear seat which is equipped with a seat occupancy sensor. This sensor triggers a warning notice if the seat is occupied by a person who has not applied the safety belt. If, however, the back rest of the rear seat is folded over so that the back rest lies on a seat surface, it can happen that the warning notice is unintentionally triggered because the back rest presses on the seat surface but the safety belt has not been applied because of a folded-over back-rest.

In addition, other objects, desirable features and characteristics will become apparent from the subsequent summary and detailed description, and the appended claims, taken in conjunction with the accompanying drawings and this background.

### SUMMARY

Accordingly, one aspect of the present disclosure is to avoid triggering of the warning notice for a folded-over back rest and unused safety belt.

In one exemplary embodiment, the present disclosure provides an output device with an output unit for issuing a warning notice, wherein the output device comprises a seat occupancy sensor which is connected with a control device for activating the output unit and which is designed, in case a safety belt on a rear seat comprising a foldable back rest has not been applied, to activate the output unit via the control device, and wherein the output device comprises a switch or a button which is designed to block activation of the output unit via the control device, when the back rest is not in a sitting position. In this way triggering of a warning signal which normally should alert the occupants of a vehicle to the fact that a person sitting on the rear seat of the vehicle has not applied his/her safety belt, is suppressed when there is no person sitting on the rear seat, but the rear seat is nevertheless subjected to a load. Such a load may, for example, be caused by the fact that the rear seat back rest is folded forward and resting on the rear seat thus pressing with its weight on the seat surface. In the exemplary embodiments according to the present disclosure these “false”, i.e. unfounded warning signals can thus be avoided, since they merely represent a nuisance to the occupants of the vehicle and may distract the driver from concentrating properly.

Whether the back rest is in a sitting position, i.e. in the upright position, can be detected by the switch or button on the basis of, for example, the angle of inclination of the back rest. To this end the switch or button according to one embodiment may be operated or triggered depending upon the angle of inclination of the back rest. If the angle of inclination, i.e. the angle between the back rest and the associated seat surface is less than a certain value of for example about 90° or about 80° measured clockwise from the seat surface to the back rest, the assumption can be made that there is no person on the rear seat. In case, however, the seat occupancy sensor registers that the rear seat is subject to a load, this load must be due to a cause other than a sitting person, for example the load could be due to a suitcase or some other load such as the folded-over back rest. Accordingly the output of a warning signal is blocked by an activation of the control device via the switch or button.

In order to enable the switch or button to be triggered or operated depending upon the angle of inclination of the back rest, the switch or button may be mounted on or in a hinge, on which the back rest is pivotably arranged on the rear seat.

In order to ascertain, whether the back rest is in a sitting position, a switch or button may be alternatively or additionally arranged on a locking mechanism with which the back rest can be arrested for leaning back, or may be configured to detect the sitting position depending upon whether the back rest is arrested by the locking mechanism. In other words, the switch or button on the locking mechanism can serve as a means for determining whether the back rest is arrested by the locking mechanism. If this is not the case, it can again be assumed that the respective rear seat is not occupied by a person, i.e. that nobody is sitting on the rear seat, which is the reason for issuing a signal by means of the switch or button to block the output unit. This means that no warning signal is issued even if the seat occupancy sensor indicates that the respective seat is occupied and no safety belt is applied.

The locking mechanism may generally be arranged on an inside wall of the motor vehicle or on a post in the interior or on a hat shelf.

In a further alternative the switch or button may be designed to be operated when the back rest has reached a certain point between its two end positions. For this purpose the switch or button may be located on or in the inside wall of a motor vehicle or in the hinge on which the back rest is pivotably arranged on the rear seat.

It is also possible alternatively or additionally, to use a switch which is a contactless switch, for example, such as a switch equipped with two sensors of which the first sensor is arranged in the back rest and the second sensor in the seat surface. As soon as the back rest when folded over forms a certain angle of inclination with the seat surface the output unit is deactivated by the switch.

The switch may be a micro switch or a micro button and/or a capacitive switch and/or an inductive switch and/or a reed switch. When the switch is implemented in this way it will fit into a very small space. The capacitive and/or inductive switches in particular can also detect the direction of movement thereof in addition to the angle of inclination of the back rest.

Conveniently the switch or button may be arranged between the seat occupancy sensor and the control device.

In order to reliably detect the warning notice, the output unit may issue an acoustic and/or a visual warning notice.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIGS. 1 and 2 show a vehicle seat, the output device and a first exemplary embodiment of the switch and a back rest in the sitting position;

FIGS. 3 and 4 show the vehicle seat in the folded-over position, the output device and the switch of FIG. 2;

FIG. 5 shows the vehicle seat with a second exemplary embodiment of the switch;

FIGS. 6 and 7 show the vehicle seat with a third exemplary embodiment of the switch and the back rest in the sitting position;

FIGS. 8 and 9 show the vehicle seat in a partially folded-over position and the switch of FIG. 7;

FIG. 10 shows the vehicle seat with a fourth exemplary embodiment of the switch and the back rest in the sitting position; and

FIG. 11 shows the vehicle seat of FIG. 10 in a partially folded position.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

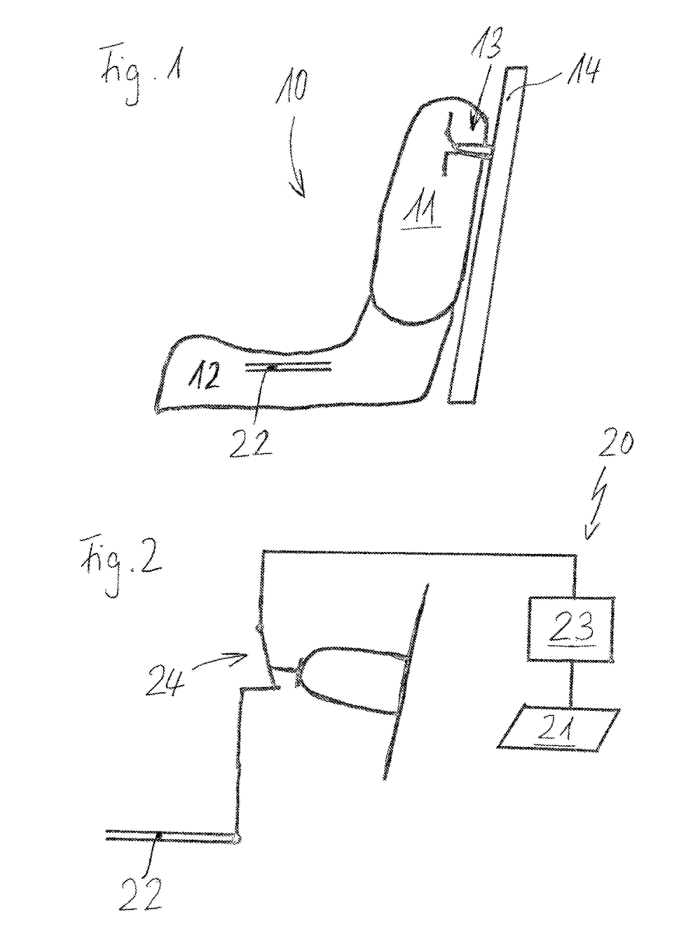

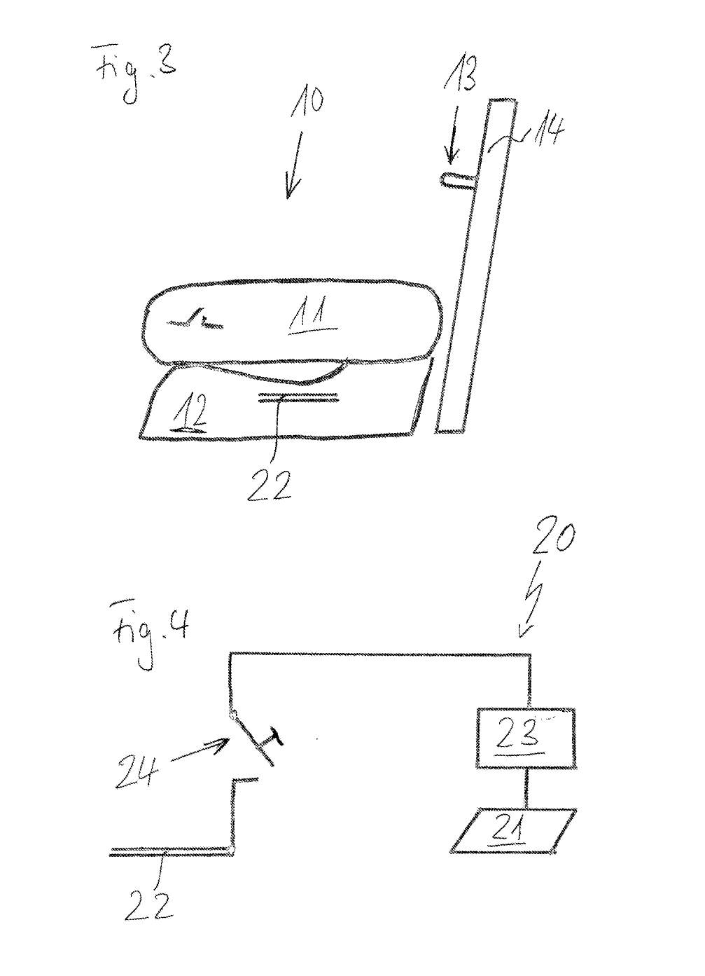

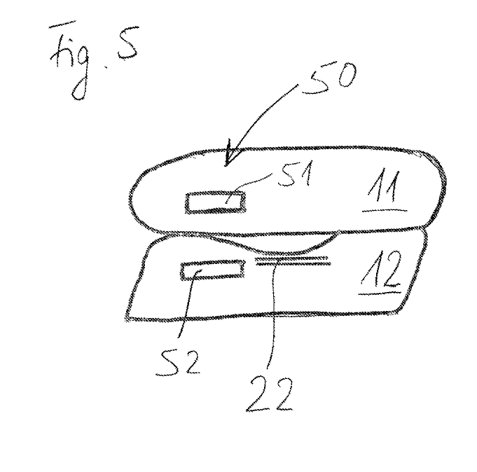

FIGS. 1 to 4 show an output device 20 with an output unit 21 for issuing a warning notice. If the safety belt (not shown here) of a rear seat 10 has not been applied the output unit 21 issues a warning notice by means of a seat occupancy sensor 22 which is connected with a control device 23. A switch 24 is arranged between the seat occupancy sensor 22 and the control device 23, which switch is closed or open depending on whether a back rest 11 is in a sitting position, i.e. in an approximately upright position or not, and which thus blocks or does not block, activation of the output unit 21 by the seat occupancy sensor 22. The output unit 21 can thus be activated by the seat occupancy sensor 22, when the switch 24 is closed (see FIGS. 1 and 2), and it cannot be activated by the seat occupancy sensor 22, when the switch 24 is opened (see FIGS. 3 and 4). In the last mentioned case the output unit 21 is thus blocked.

In an alternative not shown other circuit arrangements are possible in principle, where release of the output unit is effected by the open switch, and where blocking of the output unit is effected by the closed switch.

In the exemplary embodiment shown here the switch 24 is preferably closed (as shown in FIG. 2), when the back rest 11 has an angle of inclination (sitting position) suitable for leaning against, such as illustrated in FIG. 1. The switch 24 is opened (as shown in FIG. 4), when the back rest 11 has an angle of inclination which is not suitable for (comfortably) leaning against (position of FIG. 3). The back rest 11 can thus rest on a seat surface 12 in the folded state and can weigh it down without a warning notice being triggered, although the safety belt is not locked in a belt lock.

The switch 24 in this case is a micro switch which is operated by a locking mechanism 13. The locking mechanism 13 can click into place in the rear wall of the back rest 11. The locking mechanism 13 is fastened to a post 14 inside a motor vehicle (see FIGS. 1 and 3).

In a further exemplary embodiment shown in FIG. 5, a switch 50 is present which comprises two sensors or buttons 51 and 52, wherein the first sensor 51 is arranged in the back rest 11 and the second sensor 52 is arranged in the seat surface 12. When during folding over of the back rest 11 the distance between the sensors 51 and 52 becomes less, the switch 50 opens so that the output unit 21 is blocked. If the back rest 11 is pivoted to the right, i.e. into the sitting position, the switch 50 closes so that the output unit 21 is released again for activation by the seat occupancy sensor 22.

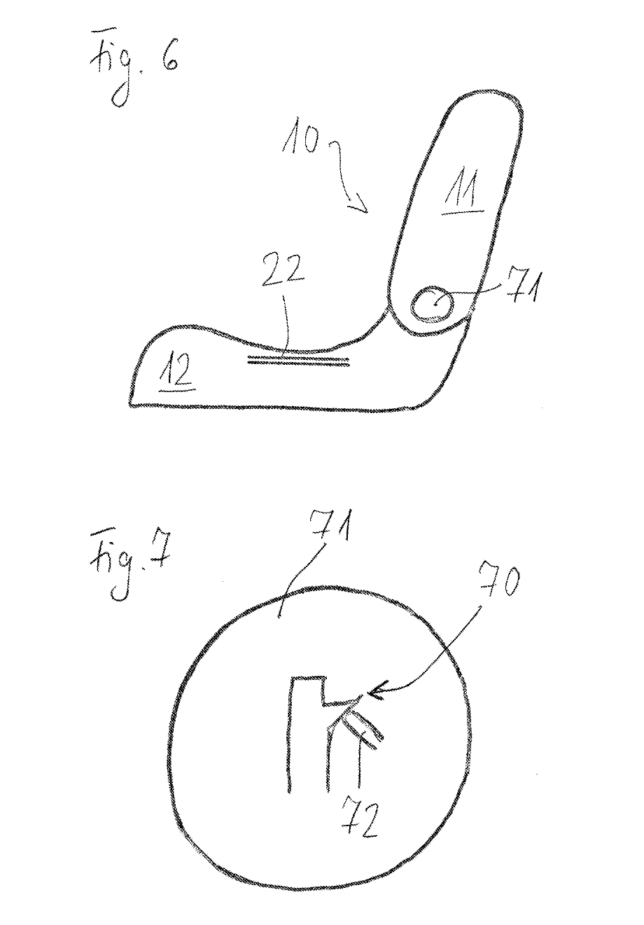

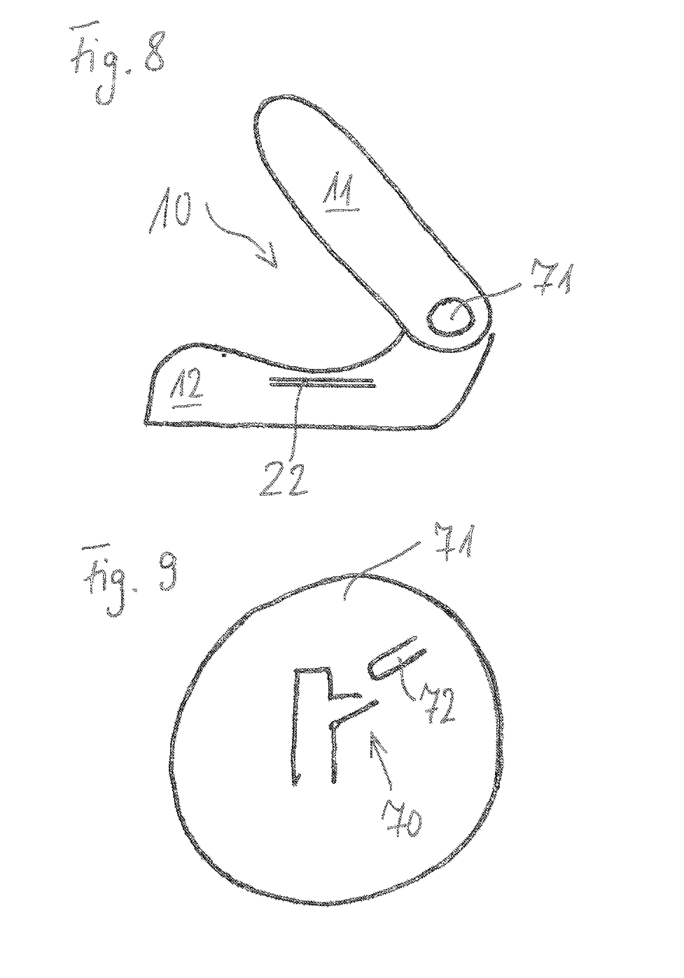

FIGS. 6 to 9 show a further exemplary embodiment of the present disclosure. In this implementation the switch 70 is arranged in a hinge 71. The switch 70 is acted upon by a bolt 72 which is permanently fixed to the back rest 11. The switch 70 is thus operated depending upon the angle of inclination of the back rest 11. When the back rest 11 has reached the position for leaning against (sitting position), the bolt 72 closes the switch 70 (see FIGS. 6 and 7). When the back rest 11 is pivoted to the left for folding over, the bolt 72 can no longer close the switch 70 so that the switch 70 automatically opens (see FIGS. 8 and 9).

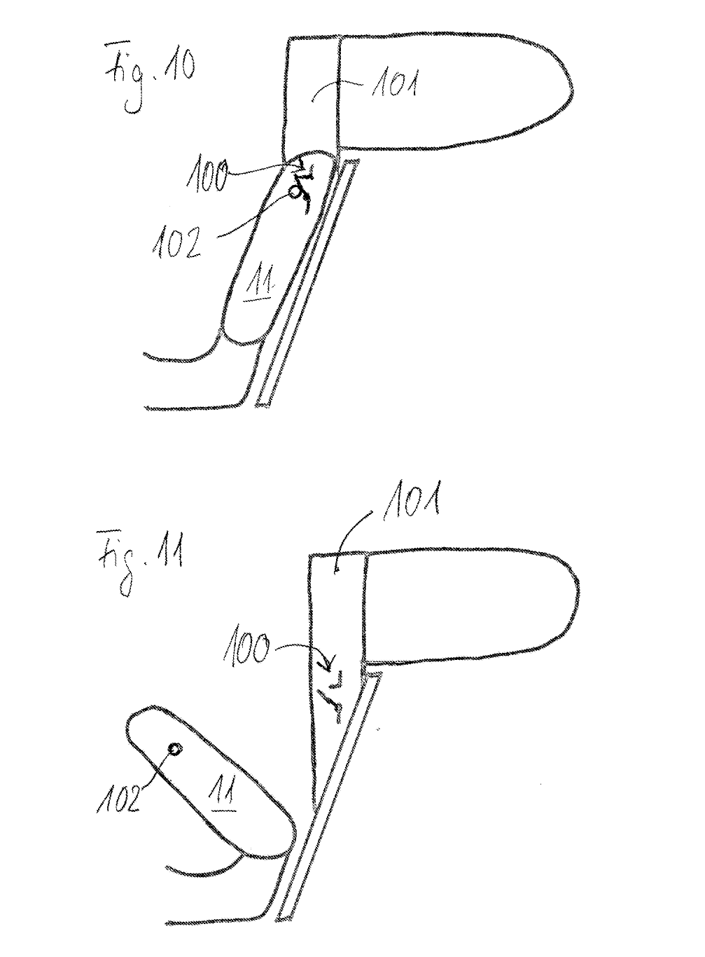

In a further exemplary embodiment a switch 100 is integrated with an inside wall 101, here in the area of the C-column, and a bolt 102 which operates the switch 100, is present in the back rest 11 (see FIGS. 10 and 11). The switch 100 can thus be operated by pivoting the back rest 11.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. An output device with an output unit for issuing a warning notice, comprising:
a seat occupancy sensor connected with a control device for activating the output unit and designed, in case a safety belt of a rear seat comprising a foldable back rest has not been applied, to activate the output unit via the control device,
wherein the output device comprises a switch or button designed to block activation of the output unit by the control device, if the back rest is not in a sitting position.

2. The output device according to claim 1, wherein the switch or button is designed to detect the sitting position depending upon the angle of inclination of the back rest.

3. The output device according to claim 1, wherein the switch or button is mounted on or in a hinge on which the back rest on the rear seat is pivotably mounted.

4. The output device according to claim 1, wherein the switch or button is arranged on a locking mechanism with which the back rest is arrested for leaning against, and designed to detect the sitting position depending upon whether the back rest is arrested by the locking mechanism.

5. The output device according to claim 4, wherein the locking mechanism is arranged on an inside wall of the motor vehicle.

6. The output device according to claim 1, wherein the switch or button is designed to be operated or triggered if the back rest reaches a certain position between its two end positions.

7. The output device according to claim 1, wherein the switch comprises two sensors, of which the first sensor is arranged in the back rest and the second sensor is arranged in the seat surface.

8. The output device according to claim 1, wherein the switch is a micro switch or micro button.

9. The output device according to claim 1, wherein the switch is a capacitive switch.

10. The output device according to claim 1, wherein the switch is an inductive switch.

11. The output device according to claim 1, wherein the switch is a reed switch.

12. The output device according to claim 3, wherein the switch is a potentiometer.

13. The output device according to claim 1, wherein the switch or the button is arranged between the seat occupancy sensor and the control device.

14. The output device according to claim 1, wherein the output device issues at least one of an acoustic and visual warning notice.

15. A motor vehicle, comprising:
an output device with an output unit for issuing a warning notice, the output device including:
a seat occupancy sensor connected with a control device for activating the output unit and designed, in case a safety belt of a rear seat comprising a foldable back rest has not been applied, to activate the output unit via the control device,
wherein the output device comprises a switch or button designed to block activation of the output unit by the control device, if the back rest is not in a sitting position, and
wherein the switch or button is designed to detect the sitting position depending upon the angle of inclination of the back rest.
